(19) United States
(12) Patent Application Publication
(10) Pub. No.: US 2026/0194870 A1
(43) Pub. Date: Jul. 9, 2026

(54) METHOD FOR TRAINING A MACHINE LEARNING MODEL

(71) Applicant: Robert Bosch GmbH, Stuttgart (DE)

(72) Inventors: Reinis Cimurs, Stuttgart (DE); Benjamin Coors, Stuttgart (DE); Johannes Goth, Wildberg (DE)

(21) Appl. No.: 19/130,382

(22) PCT Filed: Mar. 21, 2024
(86) PCT No.: PCT/EP2024/057651

§ 371 Date: May 15, 2025

(30) Foreign Application Priority Data
Apr. 11, 2023 (DE) 10 2023 203 277.5

(51) Int. Cl. G05B 13/02; G06N 20/00

(52) U.S. Cl. CPC G05B 13/0265; G06N 20/00

(57) ABSTRACT

A method for training a machine learning model. For training data containing a plurality of training data elements that each specify a pair including a training input and a target processing result for said training input from a result space, the method includes dividing the result space into regions, ascertaining an acceptance rate depending on the number of regions for which the training data include at least one training data element that indicates a target processing result located in the respective region, and, for each training iteration, selecting training data elements from the training data depending on the acceptance rate and training the machine learning model using the training data elements selected for the training iteration.

### FIELD

The present disclosure relates to methods for training a machine learning model.

### BACKGROUND INFORMATION

Machine learning models are trained using training data. The machine learning model adapts to the training data that it “sees” during training; i.e. the training data elements that are fed to it during training and on the basis of which it is evaluated and adapted. If the machine learning model sees little training data for a specific range of scenarios during training (or sees it rarely in relation to other training data), it will be relatively poorly trained for this range of scenarios (e.g. control scenarios) compared to other ranges and may deliver poor results for these ranges, i.e. generalize poorly with respect to these ranges. For this reason, approaches are sought that enable a machine learning model to be trained in such a way that it has a high generalization ability and thus provides good results in a wide range of scenarios, e.g. traffic situations.

### SUMMARY

According to various example embodiments of the present invention, a method for training a machine learning model, in particular for implementing a control strategy for a robot device (i.e. so that the machine learning model represents a control strategy for a robot device such as an autonomous vehicle), is provided, which, for training data containing a plurality of training data elements that each specify a pair consisting of a training input, in particular training sensor data describing a state of a robot device and/or a surroundings of the robot device, and a target processing result for said training input from a result space, in particular a robot device control action space, dividing the result space into regions, ascertaining an acceptance rate depending on the number of regions for which the training data comprise at least one training data element that indicates a target processing result located in the respective region, and, for each training iteration,
selecting training data elements from the training data by repeatedly
   sampling a training data element from the training data;
   ascertaining the ratio of the number of training data elements selected for the training iteration that indicate target processing results that are located in the region in which the target processing result indicating the sampled training data element is located to the number of training data elements selected for the training iteration and
   selecting the sampled training data element for the training iteration if the ascertained ratio is less than the acceptance rate; and
training the machine learning model using the training data elements selected for the training iteration.

Compared to using training data without filtering training data elements as provided in the described method of the present invention by possibly not accepting sampled training data elements, the above-described method reduces the risk of overfitting when training the machine learning model to target processing results that are overrepresented in the training data (i.e., e.g., ranges of scenarios, e.g. types of control actions). This increases the generalization ability of the machine learning model. Training data elements that are unimportant in the sense that they do not contain any new information (with respect to the target processing results) are filtered out, wherein the filtering depends on the target processing results (e.g. actions) and not on the training input. The significance of the input (e.g. a state) is therefore determined by its target processing result (e.g. action), not by the input itself (e.g. because there is more than one possible action per state). Thus the reaction to a state is assigned significance, for instance, not the state itself.

The above-described method of the present invention improves the training result and can also reduce the training time, because filtering out unimportant training data elements can reduce the total number of training data elements and thus shorten the training for an epoch (with multiple training iterations) via the (thus filtered) training data. The efficient use of data thus makes it possible to achieve a reduction in training time by not training on many “similar” training data elements (wherein “similar” training data elements are, for instance, such that contain the same (or a very similar) target processing result, e.g. action).

The training is behavioral cloning, for instance, e.g., for learning a driving model or a driving strategy. In this case, the described filtering of training data elements by online filtering (e.g. during training, i.e. online, compared to filtering during preprocessing, i.e. offline) of the training data in the action space can improve the realism of the driver model or driving strategy by improving the selection of training data elements. In such an application, filtering out overrepresented or unimportant training data elements means that recorded driving behavior that is underrepresented in the training data is given greater consideration during training (compared to sampling from the training data without filtering).

Behavioral cloning is an example of supervised learning. The method can also be applied to other methods for supervised learning. The target processing results can be actions, but the method is not limited to this; the target processing results can also be labels for supervised learning, for example, for instance classes for training a machine learning model (e.g. a neural network) for image classification.

Various embodiment examples of the present invention are specified in the following.

Embodiment example 1 is a method for training a machine learning model as described above.

Embodiment example 2 is a method according to embodiment example 1, wherein the acceptance rate is ascertained such that it is inversely proportional to the number of regions for which the training data comprise at least one training data element that indicates a target processing result located in the respective region.

This makes it possible to ensure that the training data elements are evenly distributed over the regions for which the training data contains training data elements.

Embodiment example 3 is a method according to embodiment example 1 or 2, wherein the result space has multiple dimensions and is divided into the regions by dividing the range of values of each dimension into intervals and defining each region of the result space as a combination of intervals which each have one interval per dimension.

The regions (multidimensional bins) are therefore combinations of (one-dimensional) bins of the individual dimensions. This ensures that the considered training data elements (and the considered combinations, for instance) are distributed over combinations of cases occurring in each dimension.

Embodiment example 4 is a method according to one of embodiment examples 1 to 3, wherein, for each training data element, the training input includes state information and the target processing result indicates a control action (of an agent).

In particular in the application of learning a control strategy, the above-described method ensures that relevant, but in reality (and thus possibly in the training data) relatively rarely occurring, situations (such as accident avoidance maneuvers) are taken into account so often during training that the learned control strategy can handle such situations correctly.

Embodiment example 5 is a method according to one of embodiment examples 1 to 4, comprising training the machine learning model using the training data elements selected for the training iteration by means of reinforcement learning or supervised learning.

A loss (i.e. loss or deviation) is calculated for each training iteration, for example, and the machine learning model (e.g. a neural network) is adapted to reduce the loss. Filtering training data elements as described above has the abovementioned advantages in particular for these training methods.

Embodiment example 6 is a method for controlling a technical system, comprising training a machine learning model to control the technical system according to one of embodiment examples 1 to 5 and controlling the technical system using the trained machine learning model.

Embodiment example 7 is a data processing device configured to carry out the method according to one of embodiment examples 1 to 6.

Embodiment example 8 is a computer program comprising instructions that, when executed by a processor, cause said processor to carry out a method according to one of embodiment examples 1 to 6.

Embodiment example 9 is a computer-readable medium which stores instructions that, when executed by a processor, cause said processor to carry out a method according to one of embodiment examples 1 to 6.

In the figures, like reference signs generally refer to the same parts throughout the different views. The figures are not necessarily to scale, wherein emphasis is instead generally placed on representing certain principles of the present invention. Various aspects are described in the following description with reference to the figures.

### BRIEF DESCRIPTION OF THE DRAWINGS

FIG. 1 shows a vehicle.

FIG. 2 shows a visualization of the distribution of scenarios of original training data.

FIG. 3 shows a visualization of the distribution of scenarios in training data selected for training, according to one example embodiment of the present invention.

FIG. 4 illustrates a training method according to an embodiment example of the present invention.

FIG. 5 shows a flowchart illustrating a method for training a machine learning model according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure to form new aspects.

Different examples of the present invention are described in more detail in the following.

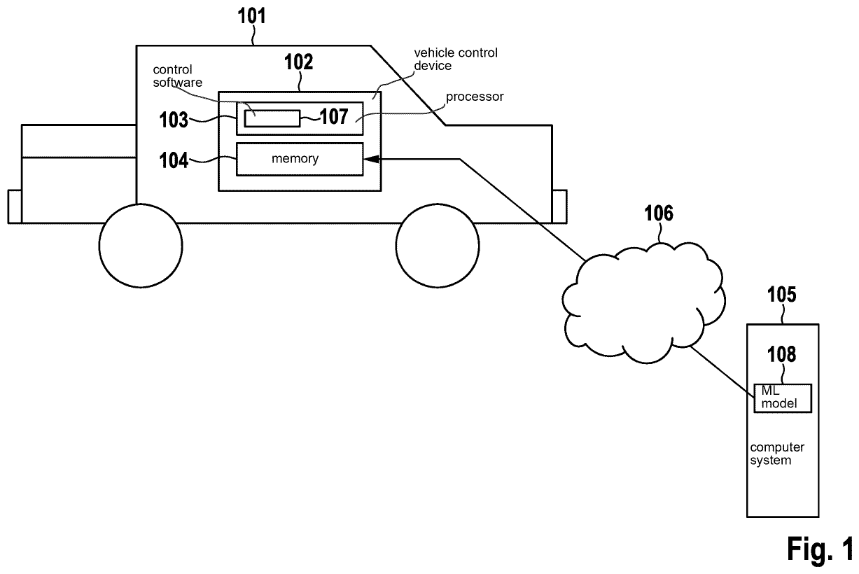

FIG. 1 shows a vehicle 101.

In the example of FIG. 1, a vehicle 101, for example a passenger car or truck, is provided with a vehicle control device (e.g. a vehicle control device (ECU)) 102.

The vehicle control device 102 comprises data processing components, e.g. a processor (e.g. a CPU (central processing unit)) 103 and a memory 104 for storing control software 107 according to which the vehicle control device 102 operates, and data that are processed by the processor 103. The processor 103 executes the control software 107.

The stored control software (computer program) comprises instructions, for example, that, when executed by the processor, cause the processor 103 to carry out driver assistance functions (or also to collect driving data) or to even control the vehicle autonomously.

The control software 107 is, for instance, transmitted to the vehicle 101 from a computer system 105, for example via a network 106 (or also using a storage medium such as a memory card). This can also be done during operation (or at least when the vehicle 101 is with the user), because over time the control software 107 is updated to new versions, for example.

The control software 107 can be trained by means of machine learning (ML), for example; i.e. the control software 107 implements an ML model 108 (or “machine learning model”) that is trained on the basis of training data 109, in this example from the computer system 105. The computer system 105 thus implements an ML training algorithm for training the ML model 108.

In the application example of FIG. 1, the objective is therefore (data-based) learning of a control strategy for controlling an automated vehicle (ego control strategy application) or also of agents for a simulation (driving model application, e.g. for simulating traffic participants for testing and/or evaluating a further control strategy). In this case, the training data consist of recorded sequences from the real world, for example. Each training data element contains (at least) one pair consisting of a training input, in this case an observation, and a target processing result (for the training input).

Each observation contains information about the state of the agent (i.e. in this example the vehicle) and its surroundings at a particular time t. An observation can, for example, include a vector (with speeds, etc.) or one or more rasterized images. The target processing result (also referred to as the label) for an observation in this application example includes the corresponding driving action at time t, which can be represented as low level action(s) (e.g. steering angle and acceleration) or waypoints (x-y-delta in relation to the global position and location of the agent).

In the application example of FIG. 1, for example, the machine learning model is trained using such training data with the aid of behavioral cloning in such a way that it implements a control strategy that imitates realistic driving behavior as represented by the training data by minimizing (or at least reducing) the difference between the driving styles predicted by the machine learning model 108 and the respective driving styles as indicated by the respective target processing results for each of several batches that each contain a plurality of training data elements by adapting the machine learning model 108 (i.e. the weights of a neural network).

This difference is captured by a training loss that calculates the average difference across all training data elements of the respective batch and optimizes the machine learning model in the direction of decreasing loss.

Driving actions that are more frequently represented in the training data will therefore affect the loss more than underrepresented driving actions. This makes training more difficult because real data sets contain many similar scenarios. For example, most of the vehicles traveling on the road are driving in the same lane and rarely carry out lane changes or emergency maneuvers, such as emergency braking or emergency evasive maneuvers. A control strategy trained on the basis of such training data cannot be expected to work well in underrepresented driving maneuvers or scenarios (such as emergency braking or emergency evasive maneuvers).

The objective of training a data-based driving strategy, however, is to train a control strategy that generalizes well to many different scenarios, including scenarios that occur in the training data set only with low frequency.

According to various embodiments, an approach for training a machine learning model is provided that improves generalization of the machine learning model to scenarios that occur in the training data but are underrepresented compared to other more frequently occurring scenarios.

According to various embodiments, the generalization of the machine learning model is improved by selecting for its training a subset of the training data that is more balanced and in which different scenarios (in the application of FIG. 1, for example, defined by their respective driving actions) occur with similar frequency.

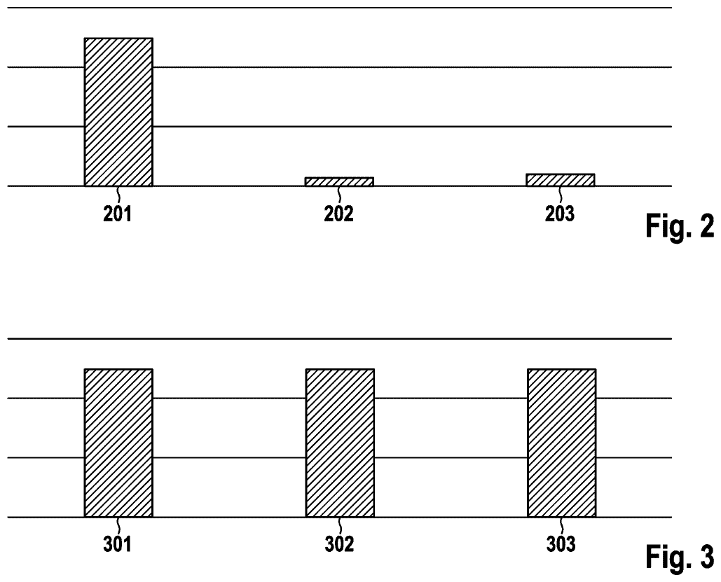

FIG. 2 shows a visualization of the distribution of scenarios (driving in a lane 201, emergency braking 202, lane changing 203) in the original, unbalanced training data.

FIG. 3 shows a visualization of the distribution of scenarios (driving in a lane 301, emergency braking 302, lane changing 303) in the selected training data. In these, the different scenarios are much more balanced.

According to various embodiments, this balance is realized by filtering training data elements, i.e. rejecting overrepresented scenarios (i.e. corresponding training element samples) in favor of underrepresented training element samples at training time. It is assumed that, for each training iteration (i.e. each batch for instance), training elements are sampled from the training data (this can be purely random, but a specific exploration strategy can also be taken into account). As a result, the machine learning model learns a more realistic behavior for scenarios (e.g. actions) that are underrepresented (in the original training data), such as lane changes or emergency braking.

In order to achieve said balance, according to various embodiments, the number of accepted, i.e. not rejected, sampled training elements is tracked broken down by scenarios (i.e. ranges of target processing results n, e.g. driving actions) when selecting training data elements.

The training data elements of all training data are divided into regions (bins) of discrete size based on the dimensions of the target processing results (e.g. the (driving) action dimensions, for instance. The dimensions here refer to the various components: if a target processing result (i.e. in the current application a driving action) is a vector of two floating point numbers, for example, the target processing result has two dimensions (e.g. acceleration and steering angle).

The target processing result dimensions (e.g. action dimensions) do not have to correspond to the dimensions of the data in the training data elements that specify the target processing results.

Each training data element includes a specification of the target processing result in the form of a sequence of waypoints, for example over five time steps, for instance. These do not express the kinematic state, however (i.e. whether the vehicle is currently braking or accelerating or how it is being steered). In order to use the kinematic state as the basis for filtering the training data elements (i.e. to carry out action balancing), the waypoints can be mapped to acceleration and/or steering actions (using an appropriate transformation). These are low dimensional compared to the waypoints and can thus improve filtering. Any target processing result that is explicitly specified in a training data element in the form of waypoints can nonetheless also be considered a specification of a target processing result in the form of actions (since the actions are specified via a corresponding mapping or transformation by the waypoints). Therefore, when reference is made here to training data elements specifying target processing results in a result space, they can do so explicitly (via elements from the result space) or via elements from another space that specify elements from the result space (e.g. sequences of waypoints that in turn specify steering actions).

The discretization of each dimension (i.e. the size of each individual bin of each component of the driving action) is calculated as follows, for example:

$$δ = \frac{{x}_{max} - {x}_{min}}{\sqrt{n}} \qquad ( 1 )$$

wherein δ is the bin size in the respective dimension, xₘₐₓ is the maximum value for the component of the driving action of the respective dimension that occurs in the training data, xₘᵢₙ is the minimum value for the component of the driving action of the respective dimension that occurs in the training data, and n is the total number of training data elements in the training data.

For target processing results n with two dimensions, this results in two-dimensional bins the rasterization of which in each dimension is given by the respective δ determined for this dimension. The raster of bins (two-dimensional or also higher) covers the region of the result space (e.g. action space) in which the training data contains target processing results. If there is more than one dimension, each bin corresponds to a combination of regions of the individual component (e.g. bin 1: steering angle between 10 degrees and 11 degrees, acceleration between 2 m/s2 and 3 m/s2; bin 2: steering angle between 11 degrees and 12 degrees, acceleration between 2 m/s2 and 3 m/s2; . . . ; bin X: steering angle between 10 degrees and 11 degrees, acceleration between 3 m/s2 and 4 m/s2 . . . ).

Training data elements are now selected during training on the basis of this classification (i.e. “online filtering” of the training data elements from the training data will be carried out). A training data element sampled from the training data is accepted only if the number of training data elements that are already in the bin to which the training data element belongs (according to its target processing result) is less than an acceptance rate.

The acceptance rate ρ is, for example, calculated as:

$$ρ = \frac{10}{N} \qquad ( 2 )$$

wherein N is the total number of bins to which at least one training data element from the training data belongs.

The acceptance rate is applied as follows. A training data element that belongs to the i-th bin is accepted if

$$\frac{{b}_{i}}{{\sum }_{j = 0}^{N ′} {b}_{j}} < ρ \qquad ( 3 )$$

wherein bᵢ and bⱼ are the number of training data elements selected so far for the current batch that belong to the i-th or j-th bins, and N′ is the total number of bins that (according to the selection so far for the current batch) contain at least one training data element.

For simplicity, it is assumed here that the bins are numbered linearly using natural numbers. For a higher dimensional raster of bins, the indices can also be indexed as a combination of natural numbers.

In this way, batches of size k are formed from the training data and then used to train an ML model (e.g. by supervised learning or reinforcement learning). Filtering (i.e. accepting sampled training data elements for training dependent on the condition of equation (3)) prevents (or at least limits) overfitting to overrepresented scenarios (i.e. target processing results) because the ML model is trained on a balanced amount of training data elements. Compared to training based on the unfiltered training data, this results in improved model generalization.

In the application of FIG. 1, a driving action is represented as mentioned above by a vector of floating point numbers, for example, (e.g. steering angle, acceleration or waypoints). The data processing device carrying out the training, e.g. the computer system 105, thus assigns each driving action to a discrete region and checks whether a currently sampled training data element (i.e. in the application of FIG. 1, an observation-action pair) should be accepted based on the number of already selected (i.e. accepted) training data elements in this region (see equation (3)). The batches used to train machine learning model 108 are then filled with only the accepted training data elements. Each accepted training data element is included once in the batch for the current training iteration. It can also be provided that each accepted training data element is included in a batch only (i.e. exactly) once per epoch (with multiple batches).

According to one embodiment, the data processing device carrying out the training, e.g. the computer system 105, carries out the following steps:
1. determining the parameters δ and ρ:
   a. loading the set of training data
   b. iterating over all training data elements of the training data
   c. recording the minimum and maximum values for each dimension of the target processing results (i.e. xₘᵢₙ and xₘₐₓ for each dimension)
   d. calculating δ (Equation (1))
   e. iterating over all of the training data elements and classifying the training data elements into the respective bins (according to their target processing results)
   f. ascertaining N and calculating p (equation (2))
   1. Online training data filtering during training for each batch
   a. sampling a training data element from the training data
   b. ascertaining the bin i to which the sampled training data element belongs and the number of training data elements already selected for the batch that belong to this bin, bi
   c. checking whether the training data element is accepted according to the acceptance rate ρ (equation (3))
   d. if the training data element is accepted, adding the training data element to the batch (if not, discarding the training data element and returning to item 2a) and increasing the number of bi by one (in other words adjusting the histogram of the selected training data elements)
   e. repeating 2.a. to 2.d. until the batch is filled to a specified size k with accepted training data elements
   f. training the machine learning model using the batch

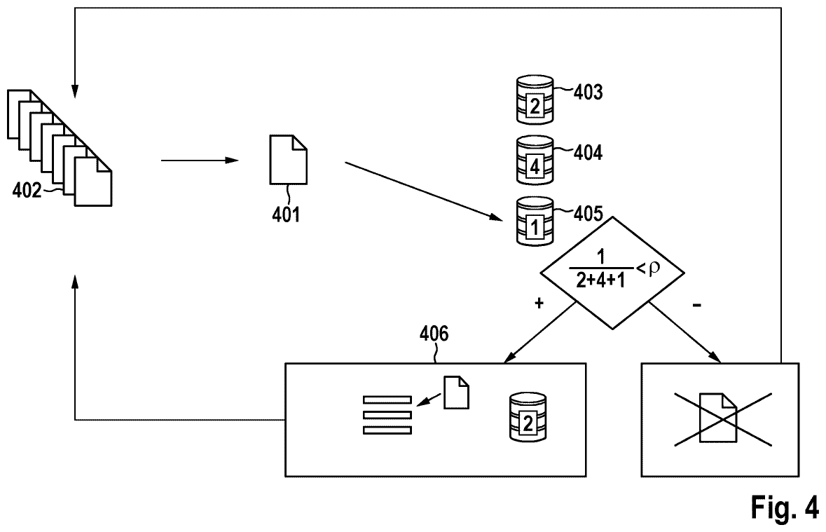

FIG. 4 illustrates the training method specified above.

A training data element 401 is sampled from the training data 402 and assigned to its associated bin 405 of (for simplicity) three bins 403, 404, 405. It is assumed that the current batch so far contains two training data elements that belong to the first bin 403 (i.e. b1=2), four training data elements (i.e. b2=4) that belong to the second bin 404 and one training data element that belongs to the third bin 405 (i.e. b3=1). Equation (3) is then checked, specifically to see whether b3/(b1+b2+b3)=1/(2+4+1) is less than the acceptance rate ρ. If this is not the case, the sampled training data element 401 is discarded and resampled. If 1/(2+4+1) is less than the acceptance rate, the sampled training data element 401 is added to the current batch 406, b3 is increased from 1 to 2, and resampled.

This training method can also be used offline for the selection of training data during preprocessing. In the case of online filtering, the selection does not have to take place in such a preprocessing. Depending on the situation, the described filtering procedure can be implemented by a data loading module for training that enables online selection, for example, or by a data preprocessing module.

As described above, the training method can be applied to behavioral cloning for learning a driver model or a driving strategy for automated driving functions. To improve the generalization of the model, the training patterns are filtered in this training method to obtain a more realistic driving behavior.

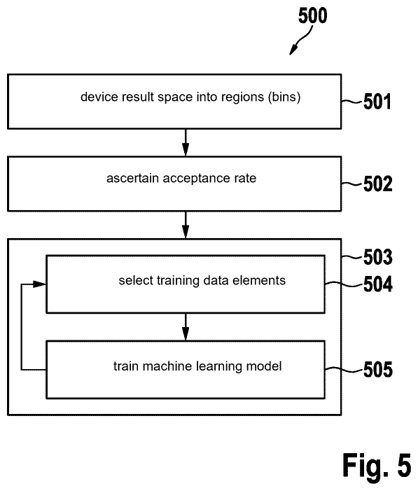

In summary, according to various embodiments, a method is provided as shown in FIG. 5.

FIG. 5 shows a flowchart 500 illustrating a method for training a machine learning model according to one embodiment.

In 501, for (given) training data containing a plurality of training data elements that each specify a pair consisting of a training input and a target processing result for said training input from a result space, the result space is divided into regions (also referred to as bins) (e.g. evenly).

In 502, an acceptance rate is ascertained depending on the number (N in the above example) of the regions for which the training data comprise at least one training data element that indicates a target processing result located in the respective region.

In 503, training data elements are selected (e.g. a (training) batch is selected) from the training data for each training iteration in 504 by repeatedly (i.e. multiple times, e.g. until a specified number of selected training data elements (i.e. e.g. a specific batch size) is reached):
sampling (i.e. (e.g. randomly) drawing) a training data element from the training data;
ascertaining the ratio of the number (bᵢ in the above example) of training data elements selected for the training iteration that indicate target processing results that are located in the region in which the target processing result indicating the sampled training data element is located to the number of training data elements (so far) selected for the training iteration and
selecting the sampled training data element for the training iteration if the ascertained ratio is less than the acceptance rate (and otherwise e.g. discarding the training data element, i.e. the training data element is not used for training the training iteration); and
   in 505, the machine learning model is trained using the training data elements selected for the training iteration.

In other words, according to various embodiments, filtering of training data is carried out on the basis of subsampling and dividing the result space into regions (bins). Dividing into regions can be based on dividing the various dimensions of the target processing results as described above. The target processing results are (low dimensional) ones, for example, such as one or a combination of speed, steering angle, waypoint(s), coordinates, acceleration, etc.

The method of FIG. 5 can be carried out by one or more computers comprising one or more data processing units. The term “data processing unit” can be understood to mean any type of entity that enables the processing of data or signals. The data or signals can, for example, be processed according to at least one (i.e. one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or also quantum sensors and quantum computers or any combination thereof. Any other way of implementing the respective functions described in more detail here can also be understood as a data processing unit or logic circuitry. One or more of the method steps described in detail here can be carried out (e.g. implemented) by a data processing unit by means of one or more specific functions executed by the data processing unit.

According to various embodiments, therefore, the method is in particular computer-implemented.

Depending on the type of input and output and according to the type of machine learning model, training is carried out using the selected training data elements, for example by supervised learning or behavioral cloning or reinforcement learning, e.g. learning a control strategy with off-policy reinforcement learning, by using the selected (i.e. filtered) set of collected experiences for controlling a technical system for training in each training iteration.

After the training, the machine learning model can be applied to sensor data ascertained by at least one sensor. The output of the machine learning model thus provides a result about a physical state of a surroundings of the at least one sensor and/or of the at least one sensor itself, or the method can comprise using the output of the trained machine learning model that it provides in response to an input of sensor data as such a result.

A machine learning model representing a control strategy is trained, for example, and, after training, used to generate a control signal for a robot device by feeding said machine learning model with sensor data relating to the robot device and/or its surroundings. The term “robot device” can be understood to mean any technical system (comprising a mechanical part the movement of which is controlled), such as a computer-controlled machine, a vehicle, a household appliance, a power tool, a manufacturing machine, a personal assistant or an access control system. A control rule or control strategy for such a technical system is learned, for instance, and the technical system is then controlled accordingly.

Training the control strategy or a machine learning model representing it can be considered training an agent (which acts in accordance with the control strategy). The general term “agent” is in particular also used here for all types of technical systems that can be controlled with the here described approaches. However, the here described approaches can be applied to any type of agent (e.g. also to an agent that is only simulated and does not physically exist).

Various embodiments can receive and use sensor signals from various sensors, such as video, radar, LiDAR, ultrasonic, motion, thermal imaging, etc., as training input (or after training as input data), for example in order to obtain sensor data relating to demonstrations or states of the system (robot and object or objects) and configurations and scenarios. The sensor data can be processed by the machine learning model. This can include classifying the sensor data or carrying out a semantic segmentation on the sensor data, for example to detect the presence of objects (in the surroundings in which the sensor data were obtained). Embodiments can be used to train a machine learning system and control a robot device, e.g. autonomously by robot manipulators, in order to accomplish various manipulation tasks under different scenarios. Embodiments can in particular be used for controlling and monitoring of the execution of manipulation tasks, e.g. in assembly lines.

The machine learning model can, for instance, be trained to measure and control, i.e. analyze (sensor) data (e.g. scalar time series), in particular action data, and then operate a respective technical system. One application example is a fail-safe operation, for which the machine learning model is trained (and used after training) to recognize significant corner cases by training it based on training data containing such significant corner cases. It can be trained to recognize safety-critical corner cases and, for example, output appropriate countermeasures as actions.

For instance, it is typically important to ensure that an automated vehicle does not collide with pedestrians and that it avoids other vehicles. According to the approach of FIG. 5, the significance of actions that are underrepresented in the training data, such as collision avoidance, can be increased, so that a machine learning model (i.e. in this case a driver model or driving strategy) based on such training data is able to generalize to more realistic driving decisions.

The approach of FIG. 5 can also be used for an active selection of data which are used by a data processing system (e.g. corresponding to the computer system 105) that implements a machine learning algorithm in addition to the training for testing, verifying and/or validating. Testing, verifying and/or validating is in particular also considered to be part of the training, i.e. a training iteration can also be a testing, verifying or validating iteration (for example because it decides whether or not to continue training).

A training data set representing driving behavior on public roads, for instance, was recorded. The data set shows largely similar behavior (driving in the lane, keeping to the speed limit, similar actions), but also contains some corner cases (lane changing, sudden braking, collision avoidance, entering or exiting a road, etc.). The approach of FIG. 5 filters the training data set based on the set filtering criteria and selects a larger variance of driving maneuvers to help the machine learning algorithm generalize to corner cases (aside from regular driving behavior).

1-9. (canceled)

10. A method for training a machine learning model for implementing a control strategy for a robot device, the method comprising:
for training data containing a plurality of training data elements that each specify a pair including: (i) a training input including training sensor data describing a state of a robot device and/or a surroundings of the robot device, and (ii) a target processing result for the training input from a result space including a robot device control action space, dividing the result space into regions;
ascertaining an acceptance rate depending on a number of the regions for which the training data include at least one training data element that indicates a target processing result located in each respective region; and
for each training iteration,
selecting training data elements from the training data by repeatedly sampling a training data element from the training data,
ascertaining a ratio of a number of the training data elements selected for the training iteration that indicate target processing results that are located in the region in which the target processing result indicating the sampled training data element is located to a number of training data elements selected for the training iteration and selecting the sampled training data element for the training iteration when the ascertained ratio is less than the acceptance rate, and
training the machine learning model using the training data elements selected for the training iteration.

11. The method according to claim 10, wherein the acceptance rate is ascertained such that it is inversely proportional to the number of regions for which the training data include at least one training data element that indicates a target processing result located in the respective region.

12. The method according to claim 10, wherein the result space has multiple dimensions and is divided into the regions by dividing a range of values of each dimension into intervals and defining each region of the result space as a combination of intervals which each have one interval per dimension.

13. The method according to claim 10, wherein, for each training data element, the training input includes state information and the target processing result indicates a control action.

14. The method according to claim 10, further comprising training the machine learning model using the training data elements selected for the training iteration using reinforcement learning or supervised learning.

15. A method for controlling a technical system, comprising:
training a machine learning model to control the technical system by:
for training data containing a plurality of training data elements that each specify a pair including: (i) a training input including training sensor data describing a state of the technical system device and/or a surroundings of the technical system, and (ii) a target processing result for the training input from a result space including a technical system control action space, dividing the result space into regions;
ascertaining an acceptance rate depending on a number of the regions for which the training data include at least one training data element that indicates a target processing result located in each respective region; and
for each training iteration,
selecting training data elements from the training data by repeatedly sampling a training data element from the training data,
ascertaining a ratio of a number of the training data elements selected for the training iteration that indicate target processing results that are located in the region in which the target processing result indicating the sampled training data element is located to a number of training data elements selected for the training iteration and selecting the sampled training data element for the training iteration when the ascertained ratio is less than the acceptance rate, and
training the machine learning model using the training data elements selected for the training iteration; and
controlling the technical system using the trained machine learning model.

16. A data processing device configured to train a machine learning model for implementing a control strategy for a robot device, the data processing device configured to perform:
for training data containing a plurality of training data elements that each specify a pair including: (i) a training input including training sensor data describing a state of a robot device and/or a surroundings of the robot device, and (ii) a target processing result for the training input from a result space including a robot device control action space, dividing the result space into regions;
ascertaining an acceptance rate depending on a number of the regions for which the training data include at least one training data element that indicates a target processing result located in each respective region; and
for each training iteration,
selecting training data elements from the training data by repeatedly sampling a training data element from the training data,
ascertaining a ratio of a number of the training data elements selected for the training iteration that indicate target processing results that are located in the region in which the target processing result indicating the sampled training data element is located to a number of training data elements selected for the training iteration and selecting the sampled training data element for the training iteration when the ascertained ratio is less than the acceptance rate, and
training the machine learning model using the training data elements selected for the training iteration.

17. A non-transitory computer-readable medium on which is stored instructions training a machine learning model for implementing a control strategy for a robot device, the instructions, when executed by a processor, causing the processor to perform the following steps:
for training data containing a plurality of training data elements that each specify a pair including: (i) a training input including training sensor data describing a state of a robot device and/or a surroundings of the robot device, and (ii) a target processing result for the training input from a result space including a robot device control action space, dividing the result space into regions;
ascertaining an acceptance rate depending on a number of the regions for which the training data include at least one training data element that indicates a target processing result located in each respective region; and
for each training iteration,
selecting training data elements from the training data by repeatedly sampling a training data element from the training data,
ascertaining a ratio of a number of the training data elements selected for the training iteration that indicate target processing results that are located in the region in which the target processing result indicating the sampled training data element is located to a number of training data elements selected for the training iteration and selecting the sampled training data element for the training iteration when the ascertained ratio is less than the acceptance rate, and
training the machine learning model using the training data elements selected for the training iteration.
